(19) United States
(12) Patent Application Publication
(10) Pub. No.: US 2007/0252029 A1
(43) Pub. Date: Nov. 1, 2007

(54) Electronics for manned or unmanned vehicles

(76) Inventor: Abe Karem, Tustin, CA (US)

Correspondence Address: Rutan & Tucker, LLP.;Hani Z. Sayed, 611 ANTON BLVD, SUITE 1400, COSTA MESA, CA, 92626, US

(21) Appl. No.: 11/506,571

(22) Filed: Aug. 18, 2006

Related U.S. Application Data
(60) Provisional application No. 60/714,608, filed on Sep. 6, 2005.

(51) Int. Cl. B64C 13/04; B64D 47/00

(52) U.S. Cl. 244/1 R; 244/228

(57) ABSTRACT

A new generation of simplified vehicle electronic systems can be operated by either an onboard (manned) or off-board (remote controlled) operator, or automatically from an on-board system without any human operator. In the latter case, preferred embodiments can provide security against operation by unauthorized personnel and/or operation in an unauthorized travel path, without a need for a flight crew operated panic button or for a remote guidance facility. In another aspect, the operating controls of an aircraft or other highly complex vehicle are sufficiently simplified that the vehicle can be operated by a flight controller interface that is located outside the flight crew station. In yet another aspect, the communications system of a vehicle is sufficiently simplified such that the vehicle can be operated using substantially only a single long-range frequency band, and a second, short-range frequency band.

This application claims priority to U.S. Provisional Application Ser. No. 60/714,608 filed Sep. 6, 2005.

### FIELD OF THE INVENTION

The field of the invention is electrical and electronic systems of vehicles, including especially manned and unmanned aircraft.

### BACKGROUND OF THE INVENTION

Modern vehicles are increasingly controlled with the help of sensors, actuators and electronics. Examples are found in the simplest farming tractors, in family cars and certainly in sophisticated aircraft.

Automated control such as anti-skid brakes (ABS in the automotive vernacular) were introduced in aircraft in the 1950's, automatic flight control of manned aircraft in the cruise phase of the flight became available in the 1940's, etc. Even the simplest of current cars have electronic control of engine fuel injection using the data of intake pressure and temperature sensors to optimize the amount of fuel injected into the engine.

When under the manual control of an onboard human operator, modern vehicles make increasing use of sensors, displays and electronics to make operation of the vehicle easier and safer. Examples of such systems which don't provide automatic control are the Global Positioning System (GPS), proximity warning to aid parking a car, Heads Up Display (HUD) which displays data to the operator while keeping visual awareness of the external environment, various warning lights, sounds or human-like warning information for functions ranging from low fuel level to long use of turning signal.

Since the 1980's, the increasing reliability and decreasing weight and cost of electrical actuation of mechanical systems caused a gradual change from manual, hydraulic and pneumatic actuation of many functions on vehicles to electrical actuation. Since the late 1970's, an effort to develop an “all electric” aircraft (no hydraulics or pneumatics) was shaping the modern aircraft.

In aircraft operated by an onboard human operator (manned aircraft) the way for such modernization in automatic control, displays, warnings and electric actuations was led by the most sophisticated military aircraft with the highest operator workload (single-seat fighters and small crew complex bombers). The rapidly increasing use of such control, display, warning and electrical systems resulted in continuous increase in the weight, volume, power, cost, maintenance labor and failure rates attributed to such systems. The modern aircraft carries hundreds of electrical and electronic boxes, actuators, displays and sensors connected by a large quantity of wire, fiber-optic and wireless communication.

Unlike the trend in consumer electronics of rapidly improving performance, reliability, user friendliness and reduction in cost, the trend in aircraft electronics in the last 5 decades is for ever increasing operational complexity and increasing cost of acquisition, upgrade and maintenance as a percentage of the complete aircraft. In order to provide both vehicle operational security and affordability, a system that reverses these trends is necessary.

Flight operation of aircraft requires significant skills and training. Except for a few standard controls of climb/descend, bank and turn the controls of aircraft are not standardized. The diversity in flight qualities (aircraft response to operator control input and to gusts) and the additional diversity in flight crew station (cockpit in the aviation vernacular) require lengthy training and separate qualification of flight crew for each type of aircraft and the extensive use of simulators. Airbus has initiated an effort to provide a common set of controls in most of its latest jet transport aircraft, which should allow a common certification of pilots for these similar aircraft. But that effort is directed to substantially similar aircraft. No effort has been made to increase the commonality of the operation of substantially different types of aircraft.

These same problems are apparent in the developmental history of unmanned vehicles. Since the 1920s, the development of vehicles operated without an onboard human operator (unmanned vehicles or UVs) had to meet the challenge of providing ever-increasing complexity of control without the benefit of onboard human supervision and intervention. This challenge caused the development of the automatic flight control for Unmanned Aerial Vehicles (UAVs) 15 years before they were incorporated in manned aircraft (from Lawrence Sperry's Aerial Torpedo of 1918 to Wiley Post's solo around-the-world flight in 1933). By the nature of their operation (no onboard operator), all UV actuations are either autonomous or operator-guided by remote control, with no direct manual operation of control surfaces, control trim, radios, landing gear, fuel pumps, valves, fans, lights, etc.

Because of their success in the last decade and the nature of the majority of their missions, Unmanned Aerial Vehicles (UAVs), and UVs in general, are driven to higher sophistication, smaller size and lower weight and cost. This trend is one of the most challenging in aeronautics, mechanical and electronic engineering. UAVs are leading manned aircraft in several technologies, including the “all electric aircraft”, integrated avionics systems, performance vs. cost of flight control systems and the critically important aspect of reducing failure rate of single-string (non-redundant) systems.

Nevertheless, despite the long-recognized need for simplified vehicle electronics, especially in the field of aircraft electronics, the tendency is still towards ever increasing complexity within types of vehicles, and ever increasing diversity across types of vehicles. For example, even though there has been significant emphasis on anti-hijacking system for commercial transport aircraft since Sep. 11, 2001, a recent US patent search of that field found that such systems still assume the use of avionics systems currently on transport aircraft, including flight crew operated panic buttons and remote guidance facilities. (See for example U.S. Pat. No. 6,641,087). One standout exception is U.S. Pat. No. 6,584,382, to the current inventor, which presents a man-machine interface for standardized control of various complex vehicles and machines, whether the operator is onboard or off-board, using a high level of automation of the vehicle or machine.

Thus, there is still a need for simplified vehicle electronics, especially in manned and unmanned aircraft, and especially electronics that can be simplified sufficiently to apply across different types of vehicles.

### SUMMARY OF THE INVENTION

The present inventions provide methods and apparatus for a new generation of simplified vehicle electronic systems. As used herein, the terms “vehicle electronics” and “vehicle electronic systems” are meant to be interpreted as including all sensors, controls, power generation, communications, lights, etc, and thus includes all systems where information or power is conducted by or through conductive wire, fiber optics, wireless, or any other means.

In one aspect, novel systems and methods allow for a vehicle (airborne, ground, waterborne or submarine) to be operated by either an onboard (manned) or off-board (remote controlled) operator, or automatically from an on-board system without any human operator. In the latter case, preferred embodiments can provide security against operation by unauthorized personnel and/or operation in an unauthorized travel path, without a need for a flight crew operated panic button or for a remote guidance facility.

In another aspect, the operating controls of an aircraft or other highly complex vehicle are sufficiently simplified that the vehicle can be operated by a flight controller interface that is located outside the flight crew station.

In yet another aspect, the communications system of a vehicle is sufficiently simplified such that the vehicle can be operated using substantially only a single long-range frequency band, and a second, short-range frequency band.

In still another aspect, the displays and controls of a highly complex vehicle are sufficiently simplified such that a control panel that would normally contain more than 20, 50, or even 100 line replaceable units (LRUs) that have a manual control, is substituted with a control panel that contains no more than 20, 10, 5, or even 4 such LRUs.

These achievements can be implemented by adding as standard items, sensors, subsystems and functions that are currently not available in most aircraft, or are only installed individually as options at added cost. These achievements can also be realized in part by reversing the trend in aircraft electronics of having a large number of electrical and electronic boxes and boards and a very large interconnecting harness. Among other things, the present inventor contemplates using a very high level of electrical and electronic hardware integration (maximum functions in minimum hardware) to achieve:
Reduced number of components, boards and boxes.
Reduced harness size and complexity.
Improved reliability, reduced number of failure points, within a single-string system.
Reduced vulnerability to enemy actions and to accidental fire through reduced exposed area.
Reduced total system size, weight, power consumption and cooling requirement (improved aircraft performance and utility).
Reduced cost of acquisition, upgrade and maintenance.
Improved survivability through affordability (volume, weight, cost, maintenance, etc.) of highly redundant avionics.
Improved survivability by large physical separation of highly redundant avionics afforded by the substantially reduced harness requirement.

Significant benefits should arise from these improvements. For example, the more integrated electronics systems can be expected to standardize operation of various types of vehicles, manned and unmanned, which in turn can achieve a high level of commonality in training and operator qualifications. Additionally, the contemplated electronics systems can be expected to substantially reduced the operator workload and reduce possible operator errors and as a result improve operational safety. The contemplated avionics systems will also be substantially more compact, lighter, more reliable and less expensive than current manned aircraft avionics.

Still further, aircraft designed for manned operations, if equipped with contemplated avionics, can be operated unmanned, and vise versa. In a specific example, passenger aircraft with hundreds of people on board could safely continue flight and land itself if the flight crew is disabled. The operation of the aircraft would not require sophisticated piloting skills, and therefore, if so desired and authorized, a non-pilot (onboard or off-board) could guide the aircraft and perform a precision landing in a site not previously programmed in the aircraft or at any ground facility.

Various objects, features, aspects and advantages of the inventive subject matter will become more apparent from the following detailed description of preferred embodiments of the invention, along with the accompanying drawings in which like numerals represent like components.

### BRIEF DESCRIPTION OF THE DRAWINGS

FIG. 1A is a chart showing systems and subsystems for manned aircraft based on an advanced unmanned avionics system.

FIG. 1B is a generalized schematic of an aircraft containing redundant transceivers and human operable flight interfaces.

FIG. 2 is a list of individual prior art avionics boxes which can be found in a modern military aircraft (advanced heavy lift rotorcraft).

FIG. 3 is a listing of individual avionics boxes in a modern military aircraft (advanced heavy lift rotorcraft) according to a preferred embodiment of the present invention.

### DETAILED DESCRIPTION

The present invention contemplates a radical departure from the evolutionary development of aircraft avionics, which because it maintains the “legacy” hardware is by nature an 80 years of “patchwork”, to create a “clean slate” avionics system in order to achieve the substantial advantages of the present invention.

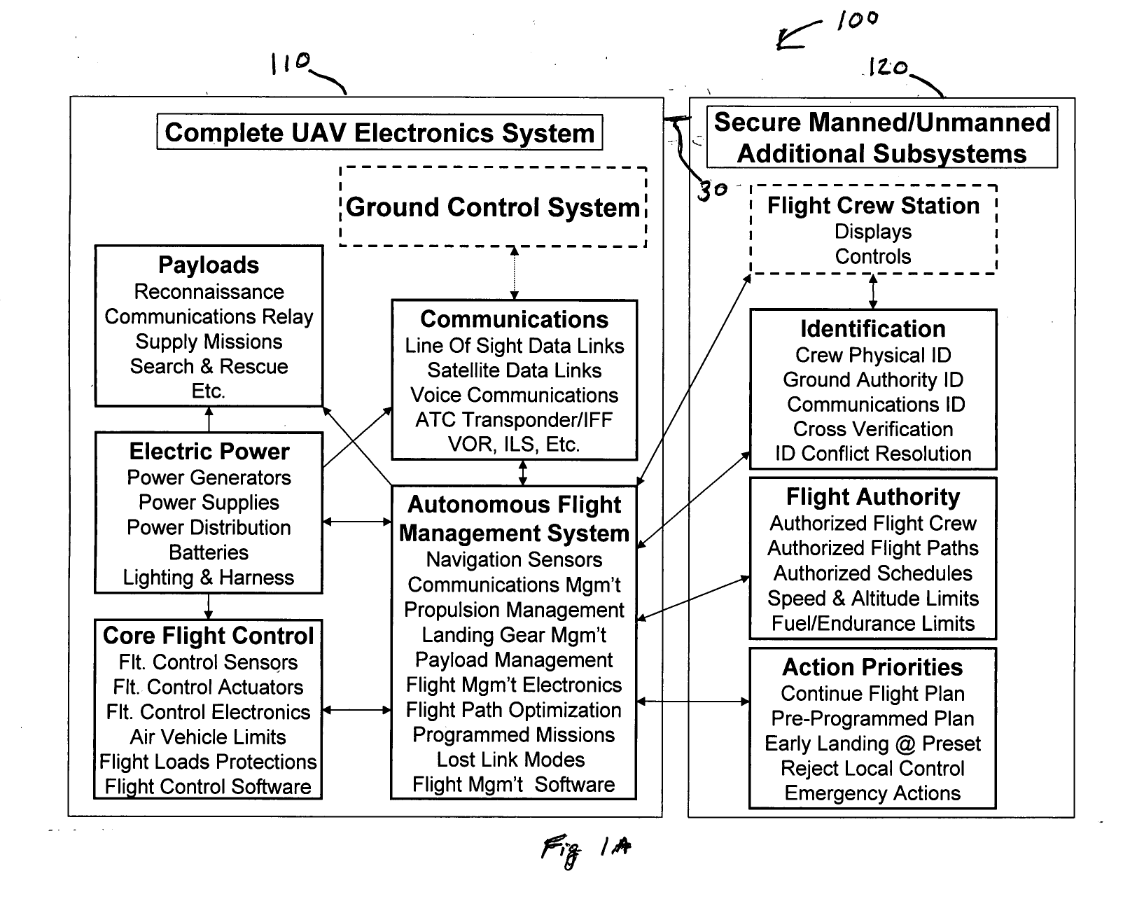

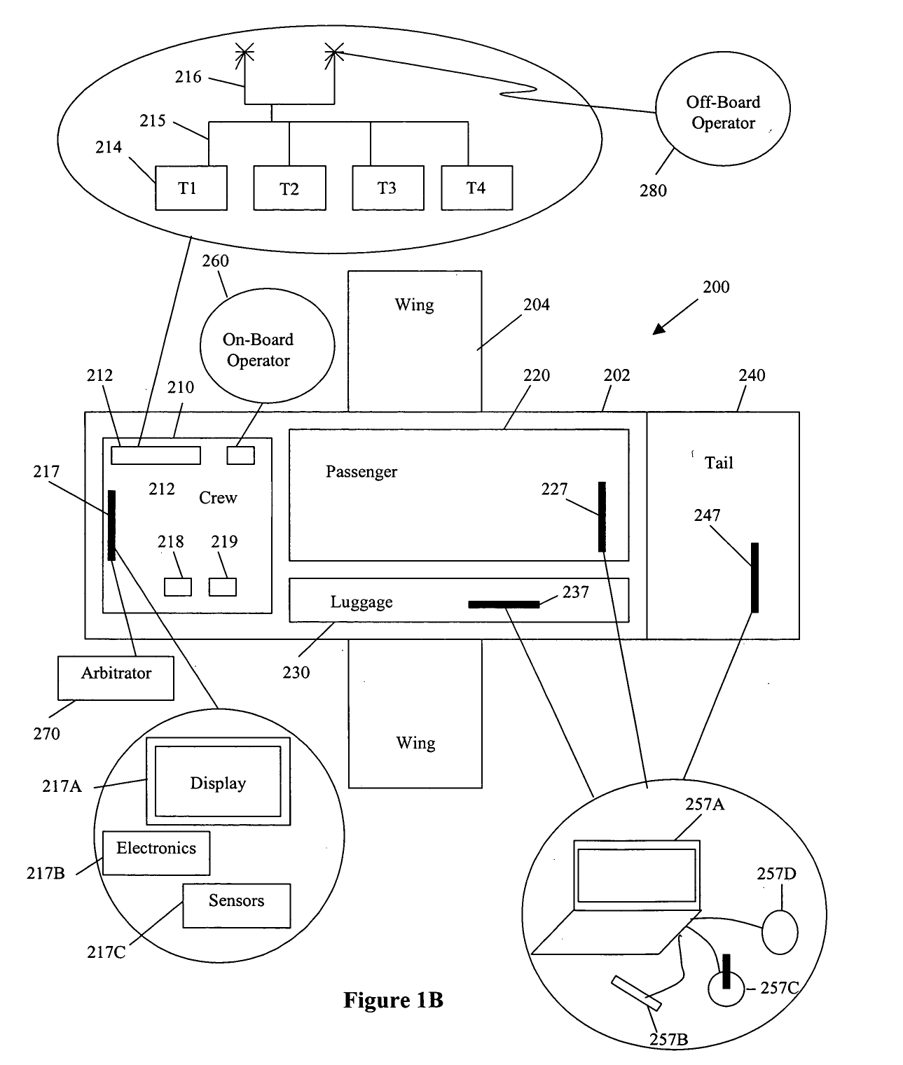

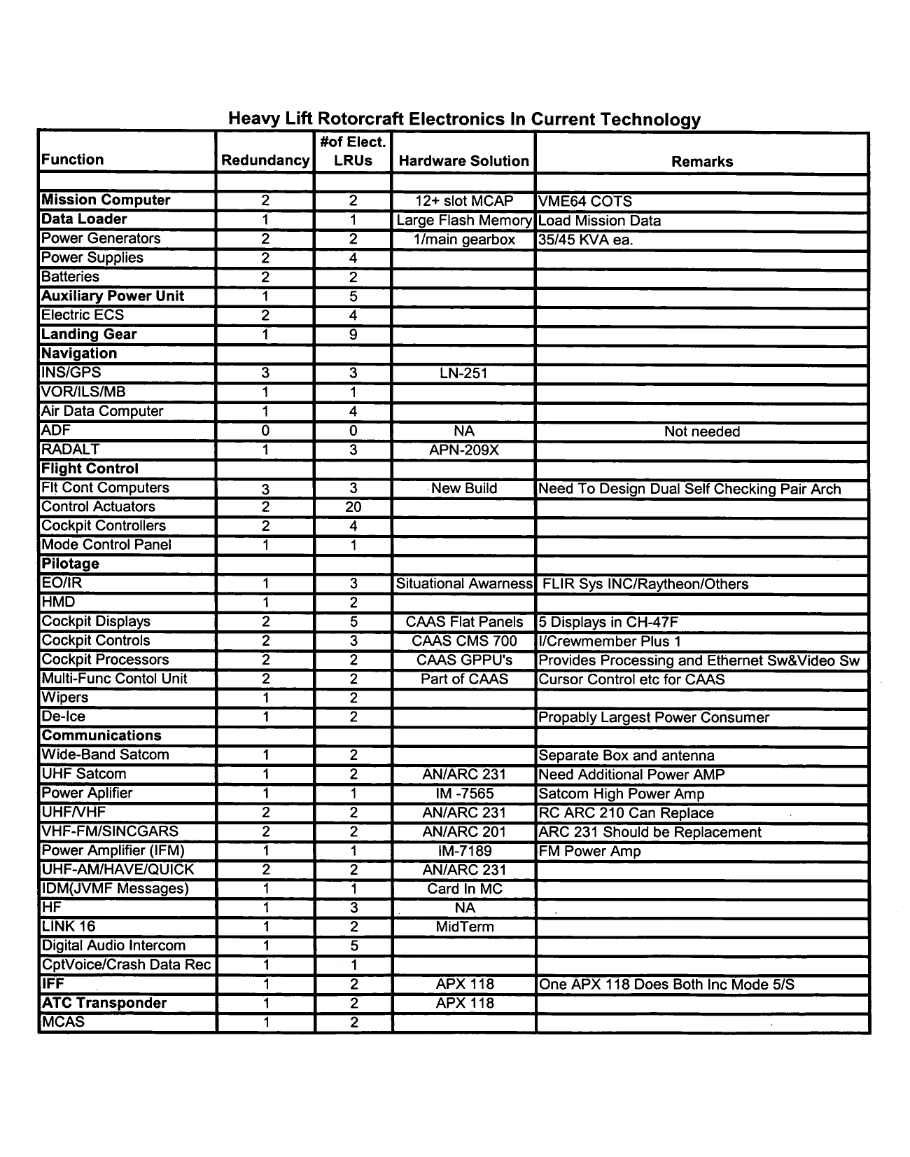

In FIG. 1A, a chart 100 generally includes components of a complete UAV electronics system 110 and optionally various secure manned/unmanned additional subsystems 120. Generic aircraft 200 should be interpreted as including

In general, many or all of the aircraft components are designed for rapid replacement as operating units, except for most of the harness assemblies, which are not easily replaced by the operators in the field. Ideally, the operating units are Line Replaceable Units or LRUs, which are defined herein to mean a composite group of modules/subassemblies performing one or more discrete functions of flight control, navigation, or communication, having at least one of a sensor and a computational functionality, and constructed as an independently packaged unit for direct installation and replacement. Among other things, this provides for easier aircraft maintenance and improved aircraft availability. In addition, to achieve reduced operator workload and errors, enhanced security and safety, etc., preferred embodiments of FIG. 1 use the capabilities of the most advanced UAV avionics as a starting point and adds: (a) functionality required for manned operations (flight crew station); (b) high level of operational security (identification, flight authority and action priorities); and (c) high level of reliance on the core flight control system and on the autonomous flight management system

FIG. 1B a generic schematic of aircraft 200 generally includes a body 202 and wings 204, a crew section 210, a passenger section 220, a luggage section 230 and a tail section 240.

Inside the crew section 210 a communications system 212 include four identical transceivers 214 coupled through wires 215 to two identical antennas 216. The multiple transceivers 214 operating within a single frequency band, and at least one of the transceivers 214 is switchable between the first and second antennas. The communication system 212 preferably uses only the single frequency band to achieve at least two, and more preferably at least three, of the following functionalities: (a) voice communication; (b) transmission and reception of imagery data; (c) identification friend or foe; (d) communication via satellite; (e) providing a communication relay; (f) transponder communication (which for example could be altitude encoding for air traffic control); and (g) anti-collision communication. The communication system 212 does not necessarily, however, perform any combinations of the various listed functionalities concurrently, and does not necessarily use all of the same hardware.

The single frequency band preferably comprises a long-range frequency band, and most preferably an X band. The single frequency band can comprises a short-range frequency band, especially wherein the short-range frequency band comprises a Ku band. Among other things, the short-range frequency band can be used to communicate directly with a satellite, and/or to relay communications between others. It is contemplated that the aircraft can use both a long-range frequency band and a short-range frequency band, at least one of which composes the single frequency band.

It should be appreciated that the wings 204 of aircraft of FIG. 1B comprise an airfoil lifting surface, and that the flight crew station has a first on-board human operable flight interface 217 capable of controlling the aircraft, and that secondary on-board human operable flight interfaces 227, 237, 247 capable of controlling the aircraft are located outside the flight crew station. Interface 227 is located in the passenger cabin section 220 of the aircraft 200, interface 247 is located in the tail section 240 of the aircraft 200, and interface 237 is located in the luggage section 230 of the aircraft 200, which is neither in the passenger cabin section 220 nor the tail section 240. Secondary flight interfaces 227, 237, 247 could be different from one another, but are preferably similar or identical, and can advantageously include at least one of a display screen 257A, a microphone 257B, a joystick 257C, and a mouse 257D.

Aircraft 200 is meant to include a wide variety of aircraft, including especially “complex aircraft”, which term is used here to mean a jet that carries at least 20 passengers, or a fighter aircraft or bomber, an executive jet, or a rotorcraft that carries more than 10 people or at least 2000 pounds of payload. Despite the complexity, such an aircraft preferably contains no more than 20 non-redundant Line Replaceable Flight Critical Units (LRFUs), more preferably no more than 10 non-redundant LRFUs, still more preferably no more than 5 non-redundant LRFUs, and still more preferably no more than 4 non-redundant LRFUs. In this case the aircraft 200 contains only four LRFUs, namely the communications system 212, the crew's flight interface 217, and two others 218, 219 to control other functions. In this particular example, is should also be appreciated that three is a triple-redundancy (two extras) of both the transponders 214 and the human operable flight interface 217, 227, 237, 247.

Crew control interface 217 should be interpreted as a collection of interconnected displays 217A, electronics 217B and sensors 217C that can provide operational flight control from either an onboard (manned) or off-board (remote controlled) operator, or can be operated automatically from an on-board system 260 without any human operator. This can be accomplished by including an on-board arbitrator 270 that uses a logical protocol to determine whether the aircraft will be controlled by the crew, the off-board operator 280, or automatically by the on-board system 260 without any human operator.

The arbitrator 270 can advantageously utilize a latching irreversible logic, and the arbitrator 270 can advantageously utilize a logic that can be inhibited and/or reversed from outside the aircraft 200. The on-board system 260 preferably provides for flight management functions in addition to flight control functions, including for example, control of operation, routing and transmission of on-board sensor data selected from the group consisting of cameras, telemetry, cockpit voice, cabin voice, cabin lights, control of door locks, and deployment of oxygen masks.

In especially preferred embodiments the on-board system 260 operates the aircraft according to a flight plan installed after an immediately preceding flight. To that end it is advantageous that the on-board system includes a functionality for crosscheck of the flight plan by both on-board and off-board personnel. It is also potentially advantageous that the on-board system 260 can operate the aircraft 200 according to a protocol that is embodied entirely on-board the aircraft.

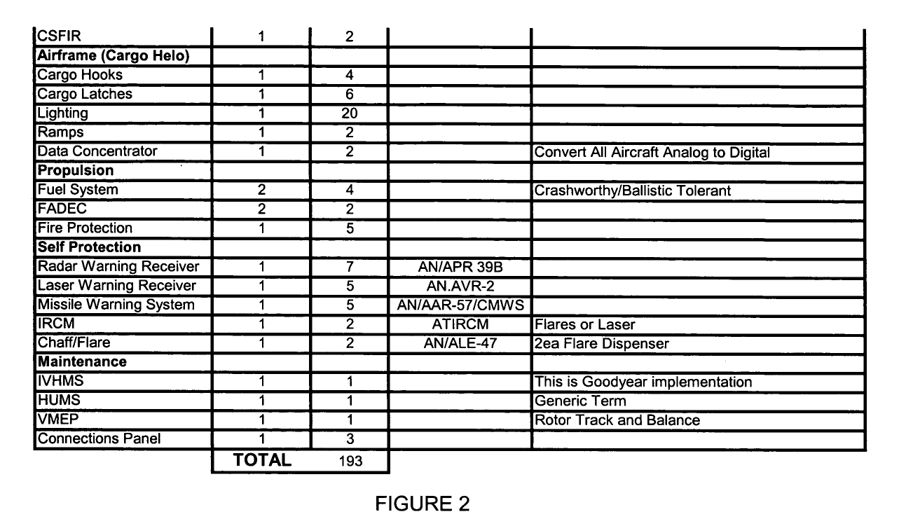

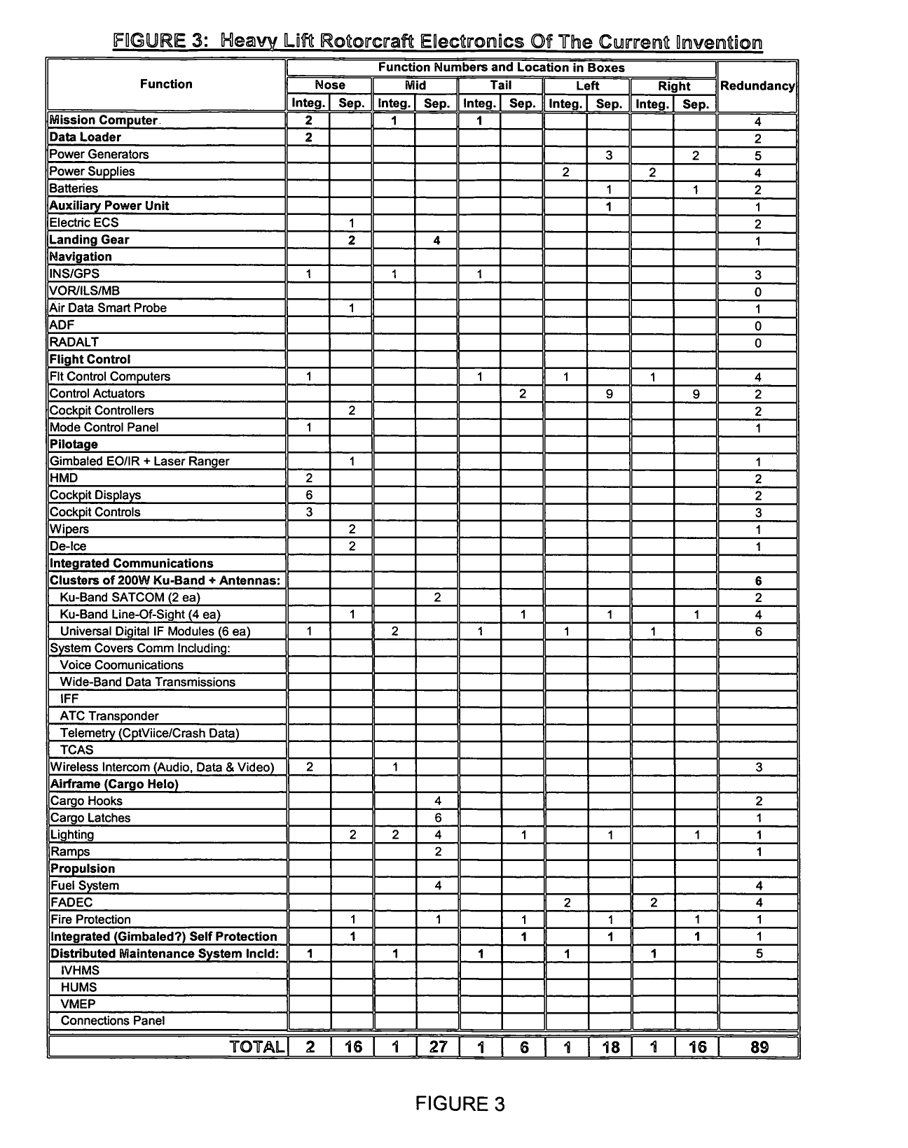

FIGS. 2 and 3 demonstrate preferred methods of achieving other advantages, including reliability, survivability, affordability, volume, weight, power, cost, etc. FIG. 2 lists 165 avionics boxes (LRUs) of a possible avionics systems built using the best “legacy” hardware. This system does not offer the level of redundancy desired for safety and survivability of a large aircraft in a hostile environment, and because of its reliance on the continued operation of a complex avionics system, it will be substantially less survivable than the mostly manually controlled aircraft of WWII.

FIG. 3 lists LRUs of a more preferred system, which provides a reduced number of LRUs, greater redundancies, and a greater physical separation of redundancies. Utilizing the concepts explored in FIGS. 2 and 3, it is contemplated that even complex aircraft, (which is defined herein to include controls for main and auxiliary power units, landing gear, navigation, flight cockpit controller, multi-function control unit, distant and local communications, IFF, ATC transponder, and airframe), can be operated from a flight crew station having less than 20 line replaceable units that have manual input, more preferably having less than 10 such units, still more preferably having less than 5 such units, and most preferably having less than 4 such units.

Viewed from another perspective, contemplated systems provide at least a 20% reduction of LRUs, (more preferably at least 30%, and still more preferably at least 40%) while still providing at least the same degree of redundancies. Similarly contemplated systems provide at least a 50% (more preferably at least 75%, and still more preferably at least 100%) increase in redundancies, without increasing the number of LRUs. Still further, contemplated systems provide all possible permutations of both reduced number of LRUs and increased redundancy listed above. Moreover, all of these improvements can be realized while providing a greater physical separation of redundant subsystems.

One significant benefit arising from simplification of, and reduction in the number of, avionics LRUs is that an aircraft can be readily designed or adapted to provide an integrated communication system having: multiple transceivers operating within a single frequency band; multiple antennas; at least one of the transceivers switchable between at least two of the antennas; and the aircraft can communicate substantially within only the single long-range frequency band (such as the X band), and a second, short-range frequency band (such as Ku band) for communications among multiple aircraft, to nearby airports, to other aircraft or surface vehicles within line of sight up to 100 nautical miles, and so forth. As used herein, the term “transceiver” is used broadly to mean electronics that can both send and receive electronic communications. The send and receive functions need to be coupled in some fashion and located in the same general area (such as on an aircraft), but the electronics for those two functions need not overlap to any great degree, not be physically co-located within the same housing, and need not function concurrently.

Another benefit is that an aircraft can be readily designed or adapted to have multiple on-board human operable flight controller interfaces, each one capable of flying the aircraft. Thus, a second flight controller interface could be located in a tail section, passenger cabin section, or other compartment of the aircraft. Such interfaces would preferably have one or more of a hand operated moveable control device (such as a mouse, a display screen, or joy stick), and also advantageously a microphone and headset or speakers. Such “emergency controller” could be used in the event that the air crew station is inoperable.

Another significant benefit arising from simplification of the avionics LRUs is that an aircraft can be readily designed or adapted to provide operational flight control from either an onboard (manned) or off-board (remote controlled) operator, or automatically from an on-board system without any human operator. To that end it is contemplated that an aircraft can have an on-board arbitrator that uses a logical protocol to determine whether the aircraft will be controlled by the on-board operator, the off-board operator, or automatically by the on-board system without any human operator. In contemplated aspects, the on-board system can operate the aircraft according to a flight plan installed after an preceding flight; the on-board system can include a functionality for cross-checking of the flight plan by both on-board and off-board personnel; the on-board system can operate the aircraft according to a protocol embodied entirely on-board the aircraft; and the arbitrator can utilize a latching irreversible logic, a logic that can be inhibited from outside the aircraft, and/or a logic that can be reversed from outside the aircraft. Also, in addition to flight control functions, it is contemplated that the electronics can provide for flight manager functions (such as control of operation, routing and transmission of on-board sensor data such as cameras, telemetry, cockpit voice, cabin voice, cabin lights, control of door locks, and deployment of oxygen masks).

It is also contemplated that the automatic systems can be configured to include functions that would preclude an authorized operator (onboard or off-board) from guiding an aircraft on a flight path that has been previously determined to be disallowed for what whatever reason. Examples of flight paths that might be disallowed include flying the aircraft into a building or a power facility. Such a system can preclude terrorist or criminal actions without the need for a panic button and without requiring control from an off-board control station.

Thus, novel embodiments of electronics for manned or unmanned vehicles have been disclosed. It should be apparent, however, to those skilled in the art that many more modifications besides those already described are possible without departing from the inventive concepts herein. For example, it should be appreciated that the inventive subject matter is applicable to all moving vehicles, and any statement related to aircraft and/or UAVs should be interpreted to include ground, water born vessels and submarines.

Moreover, in interpreting the disclosure and the proposed claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps could be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An aircraft having a communication system that comprises:
multiple transceivers operating within a single frequency band;
first and second antennas;
at least one of the transceivers switchable between the first and second antennas; and
the communication system using only the single frequency band to achieve at least two of
the following functionalities: (a) voice communication; (b) transmission and reception of imagery data; (c) identification friend or foe; (d) communication via satellite; (e) providing a communication relay; (f) transponder communication; and (g) anti-collision communication.

2. The aircraft of claim 1, wherein the communication system uses only the single frequency band to achieve at least three of the functionalities.

3. The aircraft of claim 2, wherein the single frequency band comprises a long-range frequency band.

4. The aircraft of claim 3, wherein the long-range frequency band comprises an X band.

5. The aircraft of claim 2, wherein the single frequency band comprises a short-range frequency band.

6. The aircraft of claim 5, wherein the short-range frequency band comprises a Ku band.

7. The aircraft of claim 5, wherein the communication system uses the short-range frequency band to communicate directly with a satellite.

8. The aircraft of claim 5, wherein the communication system uses the short-range frequency band to relay communications between others.

9. The aircraft of claim 2, wherein the aircraft uses both a long-range frequency band and a short-range frequency band, at least one of which composes the single frequency band.

10. An aircraft with an airfoil lifting surface having a flight crew station with a first on-board human operable flight interface capable of controlling the aircraft, and a second, on-board human operable flight interface capable of controlling the aircraft, which is located outside the flight crew station.

11. The aircraft of claim 10, wherein the second flight controller interface is located in a tail section of the aircraft.

12. The aircraft of claim 10, wherein the second flight controller interface is located in a passenger cabin section of the aircraft.

13. The aircraft of claim 10, wherein the second flight controller interface is located in a compartment of the aircraft other than a tail section and a passenger cabin section.

14. The aircraft of claim 10, wherein the interface comprises at least one of a mouse, a display screen, and a joystick.

15. The aircraft of claim 10, wherein the interface comprises a microphone.

16. A complex aircraft having with no more than 20 non-redundant Line Replaceable Flight Units.

17. The aircraft of claim 16, wherein the number of non-redundant Line Replaceable Flight Units is no more than 10.

18. The aircraft of claim 16, wherein the number of non-redundant Line Replaceable Flight Units is no more than 5.

19. The aircraft of claim 16, wherein the number of non-redundant Line Replaceable Flight Units is no more than 4.

20. A aircraft having at least a triple-redundancy (two extras) in at least one of a communication system and a human operable flight interface.

21. The aircraft of claim 20, at least two of the triple redundancies comprise identical hardware.

22. An aircraft comprising:
electronics that can provide operational flight control from either an onboard (manned) or off-board (remote controlled) operator, or be operated automatically from an on-board system without any human operator; and
an on-board arbitrator that uses a logical protocol to determine whether the aircraft will be controlled by the on-board operator, the off-board operator, or automatically by the on-board system without any human operator.

23. The aircraft of claim 22, wherein the on-board system operates the aircraft according to a flight plan installed after an immediately preceding flight.

24. The aircraft of claim 22, wherein the on-board system includes a functionality for crosscheck of the flight plan by both on-board and off-board personnel.

25. The aircraft of claim 22, wherein the on-board system operates the aircraft according to a protocol that is embodied entirely on-board the aircraft.

26. The aircraft of claim 22, wherein the arbitrator utilizes a latching irreversible logic.

27. The aircraft of claim 22, wherein the arbitrator utilizes a logic that can be inhibited from outside the aircraft.

28. The aircraft of claim 22, wherein the arbitrator utilizes a logic that can be reversed from outside the aircraft.

29. The aircraft of claim 22, wherein the electronics provides for flight management functions in addition to flight control functions.

30. The aircraft of claim 29, wherein one of the flight management functions is selected from the group consisting of control of operation, routing and transmission of on-board sensor data selected from the group consisting of cameras, telemetry, cockpit voice, cabin voice, cabin lights, control of door locks, and deployment of oxygen masks.

31. The aircraft of claim 22, further comprising a subsystem that can be configured to preclude an authorized operator, whether onboard or off-board, from guiding the aircraft on a flight path that has been previously determined to be disallowed.
